(19) United States
(12) Patent Application Publication
(10) Pub. No.: US 2006/0033308 A1
(43) Pub. Date: Feb. 16, 2006

(54) Method and system for stabilizing a car-trailer combination

(75) Inventors: Dirk Waldbauer, 65817 Eppstein (DE); Jurgen Krober, Winningen (DE)

Correspondence Address: Gerlinde M Nattler;Continental Teves, Inc, One continental Drive, Auburn Hills, MI, 48326, US

(73) Assignee: Continental Teves AG & Co.oHG

(21) Appl. No.: 10/533,857

(22) PCT Filed: Nov. 7, 2003
(86) PCT No.: PCT/EP03/50805

§ 371 Date: May 5, 2005

(51) Int. Cl. B60D 1/32

(52) U.S. Cl. 280/455.1

(57) ABSTRACT

The invention relates to a method for stabilizing a car-trailer combination, including a towing vehicle and a trailer moved by the towing vehicle. The rolling motions of the towing vehicle are monitored to detect an actual or expected unstable driving performance of the towing vehicle or car-trailer combination. Measures are taken to stabilize the driving performance when an unstable driving performance is detected or expected. These measures may include decelerating the towing vehicle dependent upon the amplitudes of the rolling motions.

### TECHNICAL FIELD

The present invention relates to a method and a device for stabilizing a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination.

### BACKGROUND OF THE INVENTION

The method at issue aims at detecting and controlling the instabilities of car-trailer combinations (motor vehicle with trailer), especially of combinations consisting of a passenger car, pickup truck or sport-utility vehicle and any trailers desired, in particular caravans, before driving conditions are encountered which the driver can no longer maintain control of the vehicle. These unstable conditions involve the rolling motions known with car-trailer combinations and the anti-phase building-up process between the towing vehicle and the trailer as well as imminent roll-over conditions at too high lateral accelerations in the event of obstacle avoidance maneuvers, lane changes, side wind, road irregularities or hasty steering maneuver requests by the driver.

Depending on the driving speed, the oscillations can decay, remain constant, or increase (undamped oscillation). When the oscillations remain constant, the car-trailer combination has reached the critical velocity. Above this speed threshold a car-trailer combination is unstable, below said threshold it is stable, that means, possible oscillations die out. The magnitude of this critical speed depends on the geometry data, the tire rigidities, the weight and the distribution of weight of the towing vehicle and the trailer. Further, the critical speed is lower in a braked driving maneuver than at constant travel. In turn, it is higher during accelerated driving than at constant travel.

Corresponding methods and devices are known in various designs (DE 199 53 413 A1, DE 199 13 342 A1, DE 197 42 707 A1, DE 100 34 222 A1, DE 199 64 048 A1).

DE 197 42 707 C2 discloses a device for damping rolling motions for at least one trailer segment towed by a towing vehicle, wherein the angular velocity of the trailer segment about the instantaneous center of rotation or the articulated angle about the instantaneous center of rotation is sensed and differentiated and taken into consideration for controlling the wheel brakes of the trailer. Acceleration sensors at different locations are used as sensors for the angular velocity. DE 199 64 048 A1 also provides a lateral acceleration sensor by means of which the rolling motion is determined. After the signal is evaluated, a periodic yawing torque shall be applied to the vehicle. DE 100 34 222 A1 determines a time for a braking intervention correct in phase, being realized in dependence on the quantity of frequency and the phase magnitude of the rolling motion.

Hence, the stabilization strategy of all design variants can be summarized roughly as follows:
Detection of the rolling motion by evaluating sensor data, with said sensors being accommodated in the towing vehicle or the trailer.
When an unstable situation is detected, the vehicle is slowed down by reducing the engine torque and building up pressure in the wheel brakes of the towing vehicle.
Additionally or alternatively a torque about the vertical axis of the towing vehicle is applied, said torque counteracting the force transmitted from the trailer to the towing vehicle and, thus, damping the oscillation.
   The latter operation can be realized alternatively by one-sided braking interventions on at least one axle or by interventions of an overriding steering system.

One problem in slowing down the vehicle involves that the critical speed of the car-trailer combination is reduced by way of braking, with the result that the oscillation of the car-trailer combination is continuously excited as long as the car-trailer combination is in the range of the critical speed. On the other hand, braking reduces the speed of the car-trailer combination so that it will leave the critical speed range after a while. It is decisive for the success of the intervention that the critical speed range, which is still decreased due to the intervention, is left again at a sufficient rapidity in order that the oscillation will not increase too much, but is dampened quickly. Hence, the problems described demand a great extent of deceleration to prevail as quickly as possible. What is in contradiction with such a high rate of deceleration is that it can make the driver insecure and can be considered as uncomfortable. In addition, the traffic in the rear can be jeopardized at high driving speeds. Also, an excessive pressure requirement can produce slip on the wheels. The reduction of the cornering force related thereto can cause an additional destabilization of the car-trailer combination.

### SUMMARY OF THE INVENTION

In view of the above, an object of the invention is to provide a method and a device that permit rating the demanded deceleration and the brake pressures demanded for each individual wheel in dependence on the situation in such a fashion that the oscillation of the car-trailer combination is dampened in a way that is optimally adapted to the driving situation.

According to the invention, this object is achieved by a method for stabilizing a car-trailer combination. The method includes monitoring rolling motions of a towing vehicle, evaluating the rolling motions with respect to critical and non-critical driving conditions, and decelerating the towing vehicle based on the monitored rolling motions.

To stabilize a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination, the rolling motions are determined and evaluated with respect to critical or uncritical driving conditions, and the towing vehicle is decelerated in dependence on the amplitudes of the rolling motions. ‘Snaking’ in this context implies that a substantially periodic lateral acceleration and yaw velocity will prevail in the towing vehicle that moves the trailer. This is not a strictly periodic oscillation, rather, temporal fluctuations in the period of the pendulum motion of the trailer can occur.

Advantageously, the method satisfies the following conditions:
The car-trailer combination is decelerated at a sufficient rate in order to prevent a major increase in the amplitude of the oscillation and to quickly dampen the oscillation.
The adjusted deceleration is dosed in a way adequate to the intensity of the determined oscillation in order that the driver subjectively senses the intervention as being adequate and comfortable, respectively, and that no feeling of a wrong intervention is imparted to the driver. Further, this will minimize that the traffic in the rear is endangered and that an endangerment is caused by the traffic in the rear.
The adjusted wheel pressures are so dosed that the demanded deceleration is reached as quickly as possible and maintained without reducing the cornering forces of the wheels. Further, a constant deceleration will safeguard that the oscillation is not additionally excited.
The brake pressure buildup satisfies the condition that safe and comfortable braking by the driver is possible at any time.
The method for stabilizing the car-trailer combination by way of the brake pressure buildup according to the invention permits implementing the function into the current ESP driving stability control systems without requiring additional hardware (actors, sensors).
Due to stopping the deceleration intervention with a short effective deceleration, the method prevents a negative effect of the intervention (additional destabilization of the car-trailer combination).
A short activation of the deceleration intervention causes actuation of the ESP function indicator lamp, even if only for a brief interval, and the short deceleration intervention initiates a deceleration impulse. The driver is informed about the unstable condition and induced to take countermeasures.

An advantage of the method involves that a snaking car-trailer combination, irrespective of the type of trailer, of the load condition of the vehicle and the trailer, the wind conditions and the steepness of the road, can always be braked in such a fashion that the oscillation is dampened sufficiently, without unnecessarily jeopardizing or burdening the driver or the traffic in the rear.

Another advantage of the method is that the demanded deceleration can be chosen depending on of how critical the rolling motion of the car-trailer combination is. This allows minimizing an endangerment of driver and traffic depending on the situation.

Still another advantage of the method prevents a reduction of the cornering forces by monitoring the tendencies of the wheels to lock and by a corresponding reduction of the pressure requirements, thereby ensuring that stability and steerability are not reduced but maintained.

In addition, the method favorably allows the driver to brake any time to an extent beyond the demanded deceleration.

Furthermore, the method is favorable because it can be implemented into each customary ESP system by merely requiring merely software.

The critical or uncritical driving conditions are advantageously detected and evaluated in such a fashion that quantities influencing the driving dynamics of the towing vehicle and representative of the amplitudes and/or the frequencies of at least one lateral quantity and/or the vehicle speed are determined, and the rolling motions are evaluated by way of the amplitudes.

The driving dynamics is favorably plotted by way of quantities of an ESP driving stability control system in such a manner that the lateral quantity is determined from the measured yaw velocity and/or the lateral acceleration and/or the difference between the measured yaw velocity and the reference or model yaw velocity. Favorably, monitoring and analyzing this differential value allows reliably detecting snaking car-trailer combinations, in particular passenger car/trailer combinations. In this method, a differential value Δ\dot{ψ}, which is representative of the deviation of the vehicle from the track predetermined by the steering wheel position, is generated from the measured yaw rate and the model-based reference yaw rate. Because this differential value represents only the deviation from the desired track, monitoring the differential value ensures the judgment of oscillations independently of a curved track that is passed e.g. due to a steering angle. Preferably, the differential value is filtered in a low-pass filter in order to cut off signal peaks triggered by the detection of coefficients of friction. The deviation between actual yaw rate and model yaw rate is additionally weighted by a factor that is calculated in response to the model yaw rate speed. The quicker the model yaw rate change is, the smaller the factor becomes, which is, however, always >0. Said factor is multiplied by the differential value or differential value signal so that a low differential value is the result in the event of a quick change of the model yaw rate. Thus, detection is only allowed at extreme oscillations, but is avoided in other cases. It is thereby taken into account that with rapid (dynamic) steering movements the vehicle is no longer able to follow the vehicle model so that the difference between the model yaw rate and the measured yaw rate shows a signal variation that would cause spurious detections. Faulty control activations are thereby avoided.

The method and the device advantageously require only a sensor equipment already provided in an ESP driving stability control system.

In addition, the time variation of the rolling motions can be taken into account so that changes in the rolling motions over predefined periods are evaluated and the tendencies determined which indicate the variation towards an uncritical or critical driving behavior are taken into consideration in the assessment and/or the deceleration of the towing vehicle.

Expediently, the car-trailer combination is stabilized by means of the following steps: Determining a deceleration quantity in response to a predetermined deceleration of the towing vehicle, comparing the deceleration quantity with a model-based deceleration demand and decelerating the towing vehicle according to the result of the comparison.

As this occurs, it is favorable for determining the brake pressures to consider a quantity representative of the actual deceleration of the car-trailer combination. Therefore, the invention arranges that the deceleration quantity (actual deceleration) is determined from the rotational behavior of the wheels, with a predefined brake pressure introduced, or from the longitudinal acceleration, and the deceleration demand (nominal deceleration) is executed in dependence on the amplitude of the rolling motion and/or the tendency of the rolling motion.

To enhance comfort and/or for reasons of stability, it is provided that the deceleration of the towing vehicle is terminated according to criteria which allow a continuous or stepped or immediate transition to non-decelerated driving.

Besides, it is favorably arranged for maintaining the steerability of the towing vehicle that the rotational behavior of the individual vehicle wheels is sensed and evaluated in terms of their slip behavior or locking behavior, that the pressure requirements are reduced or disabled when the slip behavior or locking behavior of a wheel on a vehicle axle is detected, and the pressure requirements are only enabled again when the tendency to slip or a locked condition is no longer discovered.

It is expedient that the pressure requirements on both wheels of a vehicle axle are reduced or disabled when the tendency to slip or a locked condition is discovered on at least one wheel of this vehicle axle.

To ensure the comfort of the method, while stabilization sets in as immediately as possible, it is favorably provided that the quantity of the brake pressure which is introduced into the wheel brakes when a locking behavior of at least one wheel is detected, is stored in a memory when the pressure requirement is disabled. To this end, brake pressure is introduced into the wheel brakes when termination of the locking tendency is detected, which corresponds to the stored quantity of the brake pressure or to a quantity reduced by a factor k_{red}. In order to quickly return to stable driving conditions, the brake pressure introduced when termination of the locking tendency is recognized, is continuously increased to a brake pressure that leads to the determined deceleration quantity of the towing vehicle.

It is favorable to limit stabilization interventions, more precisely deceleration demands of the controller, to those cases where high rates of deceleration can be realized and to prevent the intervention in cases where only low rates of deceleration are possible (roughly <0.3 g). The intervention is not totally prevented with this method because the possible deceleration potential cannot be discovered before the wheels reach the locking pressure level due to the deceleration intervention. Therefore, the method is provided to discontinue a deceleration intervention that is not helpful. However, the intervention must be stopped so early enough that an additional destabilization of the car-trailer combination is prevented.

The method monitors the deceleration of the car-trailer combination during a deceleration intervention. If this deceleration was unable to reach a defined threshold (roughly 0.25 g-0.3 g) after a defined interval, the deceleration intervention is stopped.

Advantageously, the deceleration is terminated at once when a deceleration value of the towing vehicle with the trailer below a threshold value is determined by way of the rotational behavior of the wheels or the longitudinal acceleration of the vehicle.

In this arrangement, the determination of the deceleration value is started with a time delay after the deceleration intervention and monitored and determined for a predefined interval.

According to a favorable embodiment, the vehicle reference speed determined in an ABS is stored at the commencement of the interval, the vehicle reference speed stored at the commencement is compared with the vehicle reference speed determined at the end, and the deceleration of the vehicle is determined from the difference between the reference speeds and the duration.

Preferably, a condition-responsive actuation of the brake light is provided in order that the deceleration intervention at the car-trailer combination is indicated to the subsequent traffic when said is braked with decelerations dangerous for the subsequent traffic. This will minimize the risk of rear-end collisions. To this end, an optical signaling device, preferably a brake light, is activated according to predefined criteria during the deceleration intervention irrespective of an application of the brake pedal.

As this occurs, the signaling device is activated in dependence on a deceleration threshold into which a hysteresis is integrated, in order to prevent a repeated activation and deactivation of the signaling device if the deceleration demand exceeds or falls below the threshold several times in a predefined period.

It is advantageous that the signaling device is activated in dependence on a minimum brake pressure that must be introduced into a wheel.

The pressure modulation of the brake pressures is carried out by means of an electric pressure fluid pump in a dual-circuit braking brake pressure transmission device, comprising the steps of introducing a brake pressure into the one and/or the other wheel brake circuit of the one brake pressure transmission circuit, maintaining the brake pressure in the one and/or the other wheel brake circuit of the one brake pressure transmission circuit and reducing the brake pressure in the one and/or the other wheel brake circuit of the one brake pressure transmission circuit, wherein a split-up of the wheel brake circuits of the one brake pressure transmission circuit into a leading and a following wheel brake circuit with different brake pressure requirement is provided, the leading wheel brake circuit is defined as the wheel brake circuit with a higher brake pressure requirement, and the steps of introducing, maintaining and reducing the brake pressure of the following wheel brake circuit are controlled or regulated by way of the leading wheel brake circuit.

An embodiment of the invention is illustrated in the accompanying drawings and described in more detail in the following.

### BRIEF DESCRIPTION OF THE DRAWINGS

In the drawings:

FIG. 1 is a vehicle with an ESP control system;

FIG. 2 is a hydraulic wiring diagram of a brake system of the invention;

FIG. 3 is a simplified flow chart showing the determination of oscillations of car-trailer combinations.

### DETAILED DESCRIPTION OF THE PREFERRED EMBODIMENTS

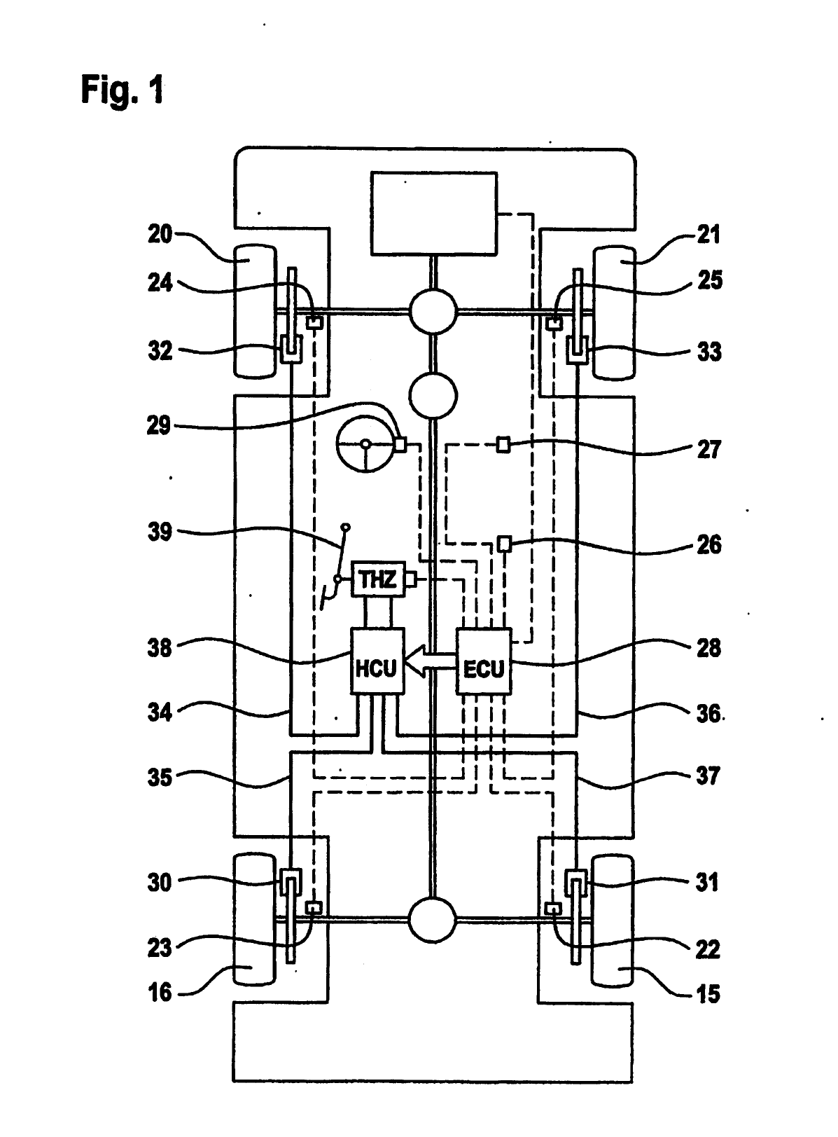

FIG. 1 shows a vehicle with an ESP control system, brake system, sensor system, and communication provisions. The four wheels have been assigned reference numerals 15, 16, 20, 21. One wheel sensor 22 to 25 is provided at each of the wheels 15, 16, 20, 21. The signals are sent to an electronic control unit 28 determining from the wheel rotational speeds the vehicle speed v by way of predetermined criteria. Further, a yaw rate sensor 26, a lateral acceleration sensor 27, and a steering angle sensor 29 are connected to electronic control unit 28. Further, each wheel includes an individually actuatable wheel brake 30, 31, 32, 33. Said brakes are hydraulically operated and receive pressurized hydraulic fluid by way of hydraulic lines 34, 35, 36, 37. The brake pressure is adjusted by way of a valve block 38, said valve block being actuated irrespective of the driver by way of electric signals produced in the electronic control unit 28. The driver can introduce brake pressure into the hydraulic lines by way of a master cylinder 1 actuated by a brake pedal 3. At least one pressure sensor P used to sense the driver's brake request is provided in the master cylinder or the hydraulic lines, respectively. The electronic control unit is connected to the engine control device by way of an interface (CAN).

It is possible to provide a statement about the respective driving situation and, thus, to realize an activated or deactivated control situation by way of a determination of the entry and exit conditions by means of the ESP control system 28 with brake system, sensor system, and communication provisions that includes the following pieces of equipment:
Four wheel speed sensors
pressure sensor (brake pressure in master cylinder pₘₐᵢₙ)
Lateral acceleration sensor (lateral acceleration signal a_{actual}, lateral inclination angle α)
Yaw rate sensor (\dot{Ψ})
Steering wheel angle sensor (steering angle δ, steering angle velocity \dot{δ})
Individually controllable wheel brakes
Hydraulic unit (HCU)
Electronic control unit (ECU).

This renders possible one main component of the method for stabilizing car-trailer combinations, i.e. the detection of driving situations, while the other main component, i.e. the interaction with the braking system, also makes use of the essential components of the driving stability control.

The method of the invention makes use of the ESP sensor equipment in order to determine a standard for the intensity of the oscillation of the car-trailer combination. Signals to be considered are the amplitudes of at least one lateral quantity (yaw rate and/or lateral acceleration and/or model yaw rate) and/or the frequencies of at least one lateral quantity (yaw rate and/or lateral acceleration and/or model yaw rate) and/or the vehicle speed. Based on these quantities, a condition detection unit will determine how critical the driving condition is. A low rate of deceleration is demanded when a condition is rather uncritical, while a high rate of deceleration is demanded when the condition is rather critical.

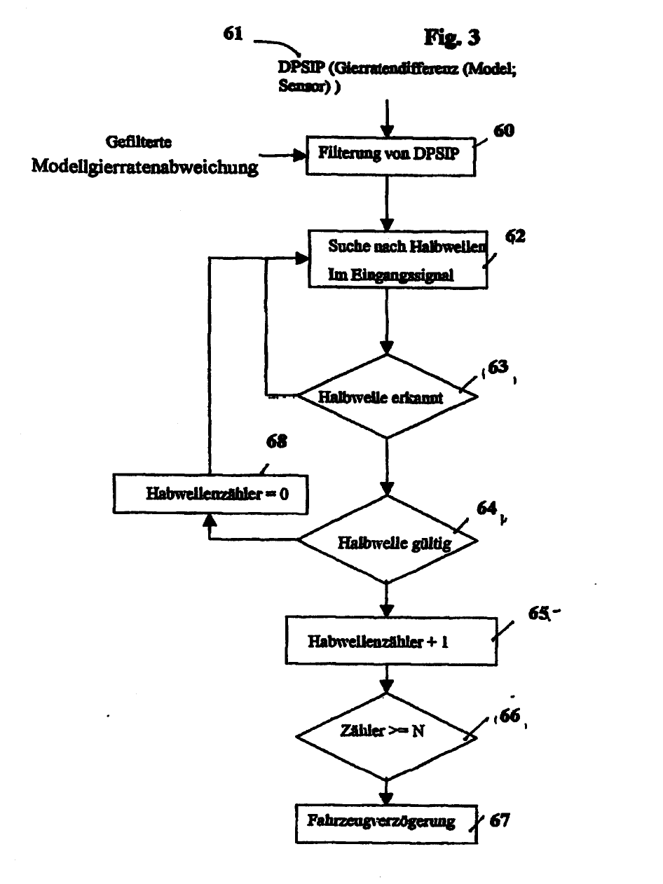

FIG. 3 shows a simplified view of the logical processes when determining the oscillations of the car-trailer combination up to the vehicle deceleration demand.

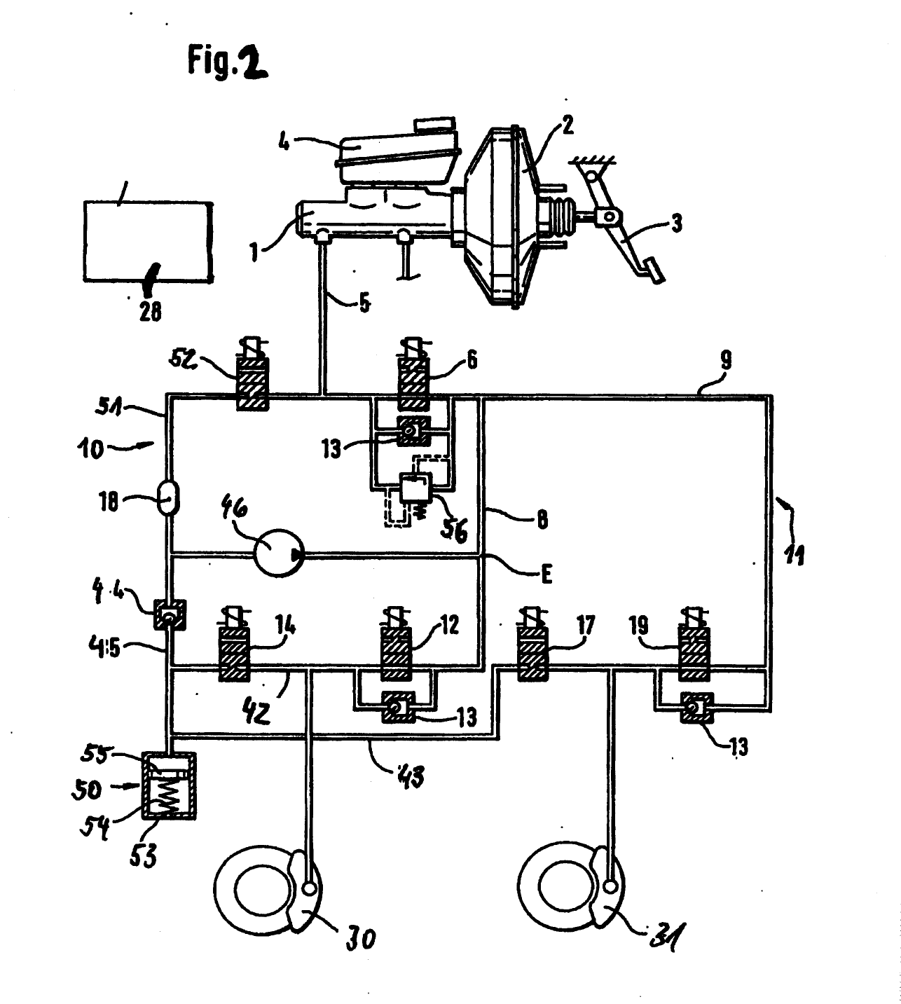

Starting from the yaw rate difference 61 (Δ\dot{ψ}) between the model yaw rate and the measured yaw rate determined in the ESP vehicle model (see e.g. the driving stability control according to FIGS. 1 and 2 and their description in DE 195 15 056 which shall be part of this application), the differential value 61 is filtered in step 60. This means that the differential value 61 undergoes low-pass filtering so that extreme peaks will not occur. Step 62 comprises the search for half waves in the input signal, which are analyzed by way of two zero crossings, one maximum, a minimum amplitude, and a defined initial gradient. It is polled in lozenge 63 whether the half wave was detected. If this is not the case, switch-back to step 62 is made and the search for half waves is continued. If the half wave was detected by way of the previous criteria, it is checked in terms of its validity in lozenge 64. To this end, the following criteria are polled:
The maximum of the half wave must exceed a defined value.
The distance of the zero crossings (half wave length) must be in the significant frequency range.
The hysteresis band must be left after a defined time.
Starting with the second wave found:
   The length of the half wave must be identical with the previous one.
   The average value of the lateral acceleration must not be higher than a defined value.
   The lateral acceleration must have the same sign at the time of the maximum of the half wave.
   The lateral acceleration must have a half wave of roughly the same duration.
   The model yaw rate must have the same sign at the time of the maximum of the half wave.
   The model yaw rate must be lower than the vehicle yaw rate by a certain amount.

If all of these criteria are satisfied, the half wave is valid, and the half wave counter is incremented in step 65. In the case of a significant amplitude decrease (current amplitude is only X % of the previous amplitude), the counter will not be incremented but maintains its value, what can lead to a later entry into the control. If not all of the criteria are satisfied, the half wave counter is reset to zero in step 68. It is found out in lozenge 66 whether N half waves are detected. This will trigger a deceleration control of the vehicle in step 67.

In an embodiment of the method, the oscillation is considered under temporal aspects in addition to the actual condition. Thus, a higher rate of deceleration must be demanded when a currently uncritical oscillation prevails that becomes stronger according to tendency though, and compared thereto, a lower rate of deceleration, or no deceleration at all, as the case may be, must be demanded when a currently critical yet decaying oscillation prevails. In particular, an early reduction of the deceleration is advantageous because the final speed of the car-trailer combination is not too low, which would otherwise jeopardize the car-trailer combination and the traffic in the rear, in particular on highways.

In another embodiment of the method of the invention, a signal representative of the actual deceleration of the car-trailer combination is reviewed for determining the brake pressures. Such a deceleration signal can easily be calculated from the ABS wheel sensor information. A signal of this type allows exactly controlling the deceleration demand. It is especially favorable in this context that externally acting forces and influences (e.g. headwind, load condition of the car-trailer combination, type of the trailer) and inclined roadways (downhill/uphill) are adjusted by control due to the feedback of the actual deceleration, with the result that the desired deceleration is always adjusted.

In another embodiment of the method, the deceleration demand is not removed abruptly but gradually along with the end of the control. This will achieve a smooth reduction of the deceleration of the car-trailer combination, what enhances the comfort and reduces the risk of disconcerting the driver.

In another embodiment of the method, the slips and decelerations of the wheels are monitored and, at the first sign of a locking tendency of a wheel on one axle, the pressure requirements on the axle are reduced or disabled and re-increased or enabled only when the tendency to lock no longer prevails. The result is that there is no reduction of the cornering forces, hence, the vehicle is not destabilized and remains steerable. It is particularly favorable that the reduction of the pressure requirement always takes place on both wheels of an axle, in order not to produce additional yaw torques that could destabilize the vehicle.

In another embodiment of the method, the current wheel pressure at the corresponding wheel is stored when a tendency to lock is detected. If the wheel no longer exhibits a tendency to lock, the pressure requirement enabled again is limited to the memorized pressure or the memorized pressure reduced by a certain value in order to prevent a further locking tendency of the wheel. However, in order to prevent a too low braking effect at the vehicle when coefficient-of-friction conditions change, favorably, the learnt locking pressure level is re-increased again. A homogeneous deceleration is thereby achieved in total, without risking that the friction value is not utilized in the event of changes of the coefficient of friction.

In another embodiment of the method, stabilization interventions, more precisely deceleration demands of the controller, are limited to those cases where high rates of deceleration can be realized and to prevent the intervention in cases where only low decelerations are possible (roughly <0.3 g). This will solve the problems in the deceleration of the vehicle with a trailer, which always occur when the critical speed of the car-trailer combination is reduced by slowing down and thus the oscillation is continuously excited. Admittedly, also the speed of the car-trailer combination is reduced so that it finally leaves the critical speed range. It is decisive for the success of the intervention that the critical speed range, which is still decreased by the intervention, is left again at a sufficient rapidity, in order that the oscillation will not be amplified too much, but dampened quickly. Thus, the problem requires a high rate of deceleration to prevail as quickly as possible.

These high rates of deceleration cannot always be attained. It has shown in driving tests that oscillations of car-trailer combinations can occur even on roadways covered with snow. If this oscillation is discovered and deceleration of the vehicle demanded, the brake pressure will quickly reach its locking level due to the low coefficient of friction. The demanded deceleration cannot be adjusted. Instead of achieving stabilization, the oscillation will be excited.

Therefore, an intervention is not totally prevented with this method of the invention because the possible deceleration potential cannot be determined before the wheels reach the locking pressure level due to the deceleration intervention. Therefore, the method is provided to discontinue a deceleration intervention that is not helpful, and the intervention is stopped. However, the intervention must be stopped early enough that an additional destabilization of the car-trailer combination is prevented.

The method for stopping the deceleration of the vehicle will be described in the following.

The method monitors the deceleration of the car-trailer combination during a deceleration intervention. If this deceleration was unable to reach a defined threshold (roughly 0.25 g-0.3 g) after a defined interval, the deceleration intervention is stopped. The deceleration can be determined either by way of the wheel speed signals, or by means of a longitudinal acceleration sensor, what is especially favorable.

Because the deceleration is required to build up at the entry into the control, it is favorable to start the observation window only a defined interval after the control entry (roughly 300 ms). In order to obtain a deceleration measurement as precise as possible, the signal is filtered over a period of further 700 ms. After 1000 ms a decision is taken whether the desired deceleration can be reached. To this end, the deceleration must exceed a defined threshold value. If this is not the case, the intervention is terminated.

A particularly favorable embodiment of the invention uses a slip monitoring system of the wheels for the decision whether the friction value allows the demanded deceleration. With this arrangement, the intervention is only terminated when a wheel has exceeded the locking pressure limit within the first 1000 ms.

Another especially favorable embodiment of the invention involves going back to the reference speed signal produced from the wheel signals when using the wheel signals for determining the deceleration. This signal determined for ABS represents the vehicle speed. The vehicle speed is stored upon expiry of the first 300 ms. Upon expiry of the following 700 ms, a rather accurate vehicle deceleration can be determined from the difference between the stored speed and the current speed and the time difference of 700 ms.

In addition, in another embodiment of the method, the traffic in the rear is warned during a deceleration intervention after detection of rolling motions of a passenger car-trailer combination of the high rate of deceleration of the car-trailer combination to be expected. The brake light is actuated as a warning signal as soon as the intervention becomes active.

In a particularly favorable embodiment of the invention, the brake light is not activated until a deceleration threshold is exceeded in order to warn the traffic in the rear only when it is really necessary.

In another especially advantageous embodiment of the invention, a hysteresis is integrated into the deceleration threshold to prevent a repeated activation and deactivation of the brake light if the deceleration signal is moving in the vicinity of the threshold and exceeds or falls below the threshold several times. A minimum pressure on at least one wheel can be demanded in addition to the actuation of the brake light. This is advantageous because with an incorrectly great deceleration signal, yet an actually low deceleration, this signal is rendered plausible with the pressure signal and unnecessary brake light activations are prevented. Sensor signals or estimated pressure signals can be used as wheel pressure signals.

Another especially favorable embodiment of the method provides realizing the deceleration demand by way of an ETR control system, which is described with reference to FIG. 2.

The brake pressure transmission device for vehicles, as illustrated in FIG. 2, is comprised of a brake cylinder 1 with a brake force booster 2, which is operated by a brake pedal 3. The brake pressure transmission device comprises two brake circuits, only one brake circuit thereof being illustrated. A supply reservoir 4 is arranged at the brake cylinder 1, which contains a pressure fluid volume and is connected to the working chamber of the brake cylinder 1 in the brake release position. The one brake pressure transmission circuit illustrated includes a brake line 5 that is connected to a working chamber of the brake cylinder 1 and has a separating valve 6 which, in its inactive position, provides an open passage for the brake line 5. The separating valve 6 is usually operated electromagnetically. However, variations where a hydraulic actuation is carried out are also feasible.

The brake line 5 branches into two brake pressure lines 8, 9 that lead to a wheel brake 30, 31, respectively. Each of the brake pressure lines 8, 9 contains an electromagnetically operable inlet valve 12, 19 which is open in its inactive position and can be switched to assume a closed position by energization of the actuating magnet. Connected in parallel to each inlet valve 12, 19 is a non-return valve 13 which opens in the direction of the brake cylinder 1. Connected in parallel to these wheel brake circuits 10, 11 is a so-called return delivery circuit which comprises return lines 45, 42, 43 with a return pump 46. By way of one outlet valve 14, 17, respectively, and return lines 42, 43, the wheel brakes 30, 31 are connected to the return line 45 and, hence, to the suction side of the return pump 46 whose pressure side is connected to the brake pressure line 8 in an opening point E between the separating valve 6 and the inlet valves 12, 19.

The return pump 46 is designed as a reciprocating piston pump with a pressure valve (not shown) and a suction valve. At the suction side of the return pump 46, there is a low-pressure accumulator 50 consisting of a housing 53 with a spring 54 and a piston 55.

A biased non-return valve 44, which opens towards the return pump, is inserted into the connection between the low-pressure accumulator 50 and the return pump.

Further, the suction side of the return pump 46 is connected to the brake cylinder 1 by way of an additional line 51 with a low-pressure damper 18 and a switch valve 52. Besides, the brake force transmission circuit includes the electronic control unit 28 for calculating the brake pressure requirements in the wheel brake circuits 10, 11. In the control unit 28 or in other electronic control units, the wheel brake circuits 10, 11 are evaluated according to the magnitude of the brake pressure requirements on the basis of the calculated brake pressure requirements in each of the wheel circuits 10, 11. The wheel brake circuits 10 or 11 are divided into a leading or a following wheel brake circuit to such an end that the wheel brake circuit, e.g. 10, with the higher deceleration demand is determined to be the leading wheel brake circuit and that the circuit with the lower deceleration demand is determined to be the following wheel brake circuit 11. In dependence on the deceleration demands in the wheel brake circuits 10, 11, controlling or regulating quantities which permit actuating the valves 12, 19, 6, 17, 52 and the return pump are generated in a stability control operation of the car-trailer combination. The following wheel brake circuit 10 or 11 is controlled or regulated by way of the leading wheel brake circuit 10 or 11, that means hydraulic pressure fluid is introduced upon pressure build-up into the following wheel brake circuit with the lower deceleration demand in the magnitude of the brake pressure requirement from or by way of the leading wheel brake circuit.

The pressure build-up in the wheel brake circuits 10, 11 takes place when the switch valve 51 is open and the separating valve 6 closed by way of actuating signals, with the separating valve 6 being normally open in the initial position and the switch valve 51 being normally closed. In this arrangement, the return pump 46 arranges for the supply of pressure fluid out of the supply reservoir 4 or the low-pressure accumulator 50, by way of the brake cylinder 1, into the wheel brake circuits 10, 11 in which pressure fluid is so introduced in conformity with the calculated brake pressure requirement. The pressure fluid is conducted to the wheel brakes 30 and 31 via the opening point E from the brake pressure line 8 of the e.g. leading wheel brake circuit 10 and into the brake pressure line 9 of the following wheel brake circuit 11 by way of the inlet valves 12 and 19. When the value of the deceleration demand calculated in dependence on the amplitudes of the rolling motion is adjusted in the following wheel brake circuit 11, the inlet valve 19 is closed by means of a switching pulse. The pressure fluid is introduced by way of the gradually actuated motor of the return pump in the leading wheel brake circuit 10 until the deceleration demand is reached. Subsequently, the inlet valve 12 remains open, and the switch valve 52 will be closed. Separating valve 6 remains closed. A constant pressure will develop.

The brake pressure in the wheel brake circuits 10, 11 is maintained, preferably when the inlet valve 12 is open. The return pump 46 is operated in a basic load condition, i.e. with the lowest conveying capacity, and energy supply, and rotational speed so that the pump piston is just about moved by the eccentric. This operation of the return pump 46 in the basic load condition is preferably controlled by way of the pulse-width modulated actuation of the pump motor when no pressure fluid volume is stored in the low-pressure accumulator 50. In a special case which is not desirable, an excess pressure that is due to the replenishment supply of the return pump out of the low-pressure accumulator 50 or damper 18 during maintaining the brake pressure in the leading wheel brake circuit 10 is effectively prevented by closing of the inlet valve 12. Closing of the inlet valve 12 is executed by a time-responsive switching pulse after closing of the switch valve 52 in driving situations, in which exceeding of the pressure beyond the value of the deceleration demand has considerable negative effects on the wheel behavior. Alternatively, the brake pressure as well can be sensed or calculated, and the inlet valve 12 can be closed in response to the brake pressure. The content of the low-pressure accumulator 50 and/or damper 18 is returned into the brake cylinder 1 and the supply reservoir 4 by way of the pressure-relief valve 56.

The pressure discharge of the leading wheel brake circuit 10 is executed by opening the separating valve 6 so that pressure fluid flows through the open inlet valve 12, the separating valve 6, and the brake cylinder 1 into the supply reservoir 4. The pressure controller 28 closes the separating valve 6 by means of switching pulses D after each pressure reduction. In the following wheel brake circuit 11, pressure fluid is returned out of the wheel brake 31 into the low-pressure accumulator 50 when the outlet valve 17 is open and the inlet valve 19 closed. The low-pressure accumulator 50 assumes a buffer function in this operation.

A correction of the brake pressure requirement of the following wheel brake circuit 11 towards a brake pressure increase is carried out by opening the inlet valve 19 out of the leading wheel brake circuit whose brake pressure requirement is also corrected in dependence on predetermined control thresholds or wherein the reduced brake pressure is tolerated.

If pressure is built up and modulated by way of this so-called ETR control (switch valve (EUV=EVR Electric Reversing Valve)—separating valve control) for the purpose of pressure modulation on all wheels, at least two wheels can be braked at any time because always one wheel pressure per circuit is not controlled by way of the inlet/outlet valves but by way of switch valve 52 and pump 46, and hence can be applied to the brakes by way of the non-return valves 13. A pressure increase method of this type is possible in all customary ESP systems and does not need any additional sensors. In contrast thereto, a modulation by way of the inlet/outlet valves on all four wheels would necessitate a particularly reliable braking detection.

1. A method for stabilizing a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination,
characterized by the following steps:
Determining and evaluating rolling motions with respect to critical or uncritical driving conditions and decelerating the towing vehicle in dependence on the amplitudes of the rolling motions.

2. The method as claimed in claim 1,
characterized in that quantities influencing the driving dynamics of the towing vehicle and representative of the amplitudes and/or the frequencies of at least one transverse quantity and/or the vehicle speed are determined, and the rolling motions are evaluated by way of the amplitudes.

3. The method as claimed in claim 2,
characterized in that the transverse quantity is determined from the measured yaw velocity and/or the transverse acceleration.

4. The method as claimed in claim 2,
characterized in that the transverse quantity is determined from the differential value of the measured yaw velocity and the reference yaw velocity.

5. The method as claimed in claim 1 or 2,
characterized in that changes of the rolling motions over predefined periods are evaluated and the tendencies determined are taken into consideration in the assessment and/or the deceleration of the towing vehicle.

6. The method as claimed in any one of claims 1 to 5,
characterized by determining a deceleration quantity in response to a predetermined deceleration of the towing vehicle, comparing the deceleration quantity with a model-based deceleration demand and decelerating the towing vehicle according to the result of the comparison.

7. The method as claimed in claim 6,
characterized in that the deceleration quantity is determined from the rotational behavior of the wheels, with a predefined braking pressure introduced, and the deceleration demand is executed in dependence on the amplitude of the rolling motion and/or the tendency of the rolling motion.

8. The method as claimed in claim 6 or 7,
characterized in that the deceleration of the towing vehicle is terminated according to criteria which allow a continuous or stepped or immediate transition to non-decelerated driving.

9. The method as claimed in any one of claims 1 to 8,
characterized in that the rotational behavior of the individual vehicle wheels is sensed and evaluated in terms of their slip behavior or locking behavior, in that the pressure requirements are reduced or disabled when the slip behavior or locking behavior of a wheel on a vehicle axle is detected, and the pressure requirements are only enabled again when the tendency to slip or a locked condition is no longer discovered.

10. The method as claimed in claim 9,
characterized in that the pressure requirements on both wheels of a vehicle axle are reduced or disabled when the tendency to slip or a locked condition is discovered on at least one wheel of this vehicle axle.

11. The method as claimed in any one of claims 1 to 10,
characterized in that the quantity of the braking pressure which is introduced into the wheel brakes when a locking behavior of at least one wheel is detected, is stored in a memory when the pressure requirement is disabled.

12. The method as claimed in claim 11,
characterized in that a braking pressure is introduced into the wheel brakes when termination of the locking tendency is detected, which corresponds to the stored quantity of the braking pressure or to a quantity reduced by a value.

13. The method as claimed in claim 11 or 12,
characterized in that the braking pressure introduced when termination of the locking tendency is recognized, is continuously increased to a braking pressure that leads to the determined deceleration quantity of the towing vehicle.

14. The method as claimed in any one of claims 8 to 13,
characterized in that the deceleration is terminated at once when a deceleration value of the towing vehicle with the trailer below a threshold value is determined by way of the rotational behavior of the wheels or the longitudinal acceleration of the vehicle.

15. The method as claimed in claim 14,
characterized in that the determination of the deceleration value is started with time delay after the deceleration intervention and monitored and determined for a predefined interval.

16. The method as claimed in claim 14 or 15,
characterized in that the vehicle reference speed determined in an ABS control is stored at the commencement of the interval, the vehicle reference speed stored at the commencement is compared with the vehicle reference speed determined at the end, and the deceleration of the vehicle is determined from the difference between the reference speeds and the duration.

17. The method as claimed in any one of claims 1 to 16,
characterized in that an optical signaling device is activated according to predefined criteria during the deceleration intervention irrespective of an application of the brake pedal.

18. The method as claimed in claim 17,
characterized in that the optical signaling device is the brake light of the towing vehicle and/or the trailer.

19. The method as claimed in claim 17 or 18,
characterized in that the signaling device is activated in dependence on a deceleration threshold which must be reached or exceeded.

20. The method as claimed in any one of claims 17 to 19,
characterized in that the signaling device is activated in dependence on a minimum braking pressure which must be introduced into a wheel.

21. The method as claimed in any one of claims 17 to 20,
characterized in that a hysteresis is integrated into the deceleration threshold in order to prevent a repeated activation and deactivation of the signaling device if the deceleration demand exceeds or falls below the threshold several times in a predefined period.

22. The method as claimed in any one of claims 1 to 21,
characterized by a pressure modulation of the braking pressures by means of an electric pressure fluid pump in a dual-circuit braking pressure transmission device, comprising the steps of introducing a braking pressure into the one and/or the other wheel brake circuit of the one braking pressure transmission circuit, maintaining the braking pressure in the one and/or the other wheel brake circuit of the one braking pressure transmission circuit and reducing the braking pressure in the one and/or the other wheel brake circuit of the one braking pressure transmission circuit, wherein a split-up of the wheel brake circuits (10, 11) of the one braking pressure transmission circuit into a leading and a following wheel brake circuit with different braking pressure requirement is provided, the leading wheel brake circuit (10 or 11) is defined as the wheel brake circuit with a higher braking pressure requirement, and the steps of introducing, maintaining and reducing the braking pressure of the following wheel brake circuit are controlled or regulated by way of the leading wheel brake circuit.

23. The method as claimed in claim 22,
characterized in that the leading brake circuit (10 or 11) of the wheel brake (30 or 31) is connected to a pressure fluid source (4) by way of opening a switch valve (52), and the pressure fluid is introduced by way of the pressure fluid pump (46) arranged in the wheel brake circuit into the leading and following wheel brake circuit, with braking pressure circuit (8, 9) being isolated from the pressure fluid source by means of a separating valve (6).

23. The method as claimed in claim 22 or 23,
characterized in that the leading brake circuit (10 or 11) of the wheel brake is connected to a pressure fluid accumulator (50), with the switch valve (52) closed, and the pressure fluid is introduced by way of the pressure fluid pump (46) arranged in the wheel brake circuit into the leading and following wheel brake circuit, with braking pressure circuit (8, 9) being isolated from pressure fluid source (4) by means of a separating valve (6).

25. The method as claimed in any one of claims 22 to 24,
characterized in that each wheel brake circuit includes an inlet valve and outlet valve (12, 19, 14, 17) and the braking pressure requirement of the leading and following wheel brake circuit is controlled by way of the inlet valve (19) of the following wheel brake circuit, and the pressure fluid delivered by the pressure fluid pump (16) according to the braking pressure requirement is controlled, with the inlet valve (12) of the leading wheel brake circuit open and the outlet valves (14, 17) of the leading and following wheel brake circuit closed.

26. The method as claimed in any one of claims 22 to 25,
characterized in that the braking pressure requirement of the following wheel brake circuit is changed out of the leading wheel brake circuit, with the inlet valve (12 or 19) of the following wheel brake circuit open and the pressure fluid pump active or passive.

27. The method as claimed in any one of claims 22 to 26,
characterized in that the braking pressure of the wheel brake circuits is maintained, with the switch valve, separating valve and outlet valve closed and the inlet valve (12 or 19) of the leading wheel brake circuit open and the outlet and inlet valve of the following wheel brake circuit closed.

28. A device for stabilizing a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination,
characterized by an ESP driving stability control with wheel speed sensors and a yaw rate sensor and/or transverse acceleration sensor and/or steering angle sensor for sensing the rotational behavior of the wheels and the yaw velocity and/or the transverse acceleration and/or the steering angle, a vehicle model for determining a model yaw velocity at least from the sensor signals,
a determining unit for producing a differential value from the measured yaw velocity and the model yaw velocity,
a determining unit calculating from the sensor signals and/or model-based quantities a deceleration quantity for the towing vehicle which is provided to the ESP driving stability control for controlling the braking pressure in the wheel brakes.

29. The device as claimed in claim 28,
characterized in that the determining unit calculates a deceleration quantity for the towing vehicle and/or the trailer in dependence on the amplitudes of the differential value.

30. The device with an optical signaling device as claimed in claim 28 or 29,
characterized in that the optical signaling device is activated according to predefined criteria during the deceleration intervention irrespective of an application of the brake pedal.

31. The device as claimed in claim 31,
characterized in that the optical signaling device is the brake light of the towing vehicle and/or the trailer.

32. The device as claimed in claim 30 or 31,
characterized in that the activation takes place in dependence on a deceleration threshold which must be reached or exceeded in order to activate the signaling device.

33. The device as claimed in any one of claims 30 to 32,
characterized in that the activation takes place in dependence on a minimum braking pressure which must be introduced into a wheel in order to activate the signaling device.

34. The method as claimed in any one of claims 30 to 33,
characterized in that a hysteresis is integrated into the deceleration threshold in order to prevent a repeated activation and deactivation of the signaling device when the deceleration demand exceeds or falls below the threshold several times in a predefined period.
